(19) United States
(12) Patent Application Publication
(10) Pub. No.: US 2015/0249245 A1
(43) Pub. Date: Sep. 3, 2015

(54) BATTERY PACK

(71) Applicant: SAMSUNG SDI CO., LTD., Yongin-si (KR)

(72) Inventor: Jang-Gun AHN, Yongin-si (KR)

(21) Appl. No.: 14/632,602

(22) Filed: Feb. 26, 2015

(30) Foreign Application Priority Data
Mar. 3, 2014 (KR) 10-2014-0024901

(51) Int. Cl. H01M 2/24; H01M 10/04; H01M 2/20; H01M 2/30

(52) U.S. Cl. CPC H01M 2/24; H01M 2/30; H01M 10/04; H01M 2/202

(57) ABSTRACT

A battery module including a first battery; and a second battery that is electrically connected to the first battery, wherein each of the first battery and the second battery include a first terminal, the first terminal being formed of a first material, a second terminal, the second terminal being formed of a second material that is different from the first material, and the second terminal having an opposite polarity from that of the first terminal, a first connecting member welded to the first terminal, the first connecting member being formed of the first material; and a second connecting member welded to the second terminal, the second connecting member being formed of the second material, and the first connecting member of the first battery is electrically connected with the second connecting member of the second battery.

### CROSS-REFERENCE TO RELATED APPLICATION

The present application claims priority under 35 U.S.C. §119 to Korean Patent Application No. 10-2014-0024901, filed on Mar. 3, 2014, in the Korean Intellectual Property Office, and entitled: “Battery Pack,” which is incorporated by reference herein in its entirety.

### BACKGROUND

1. Field

Embodiments relate to a battery pack.

2. Description of the Related Art

A power supply device may include a battery cell assembly that includes a plurality of battery cells each having a positive electrode at one end thereof and a negative electrode at the other end thereof. The plurality of battery cells may be connected to each other in series so as to obtain a required voltage.

### SUMMARY

Embodiments are directed to a battery pack.

The embodiments may be realized by providing a battery pack including a first battery; and a second battery that is electrically connected to the first battery, wherein each of the first battery and the second battery include a first terminal, the first terminal being formed of a first material, a second terminal, the second terminal being formed of a second material that is different from the first material, and the second terminal having an opposite polarity from that of the first terminal, a first connecting member welded to the first terminal, the first connecting member being formed of the first material; and a second connecting member welded to the second terminal, the second connecting member being formed of the second material, and the first connecting member of the first battery is electrically connected with the second connecting member of the second battery.

The first connecting member and the second connecting member may each include a terminal section that is welded to the terminal, a fastening section at an end of the connecting member opposite to the terminal section, and an intermediate section that connects the terminal section and the fastening section.

A plane of the terminal section may be parallel with a plane of the fastening section.

A plane of the intermediate section may be perpendicular to the plane of terminal section and the fastening section.

Each fastening section may include a protruding section, the protruding section including a fastening hole therein, and the fastening hole in the fastening section of the first connecting member of the first battery may be aligned with the fastening hole in the fastening section of the second connecting member of the second battery.

The battery pack may further include a bolt passing through the aligned fastening holes; and a nut on the bolt, the bolt and nut being coupled with the fastening section of the first connecting member of the first battery and the fastening section of the second connecting member of the second battery.

The protruding section of the first connecting member may protrude outwardly from the battery in a direction opposite to a direction in which the protruding section of the second connecting member protrudes.

The battery pack may further include a barrier between the first battery and the second battery.

The barrier may include a fastening groove that is aligned with the aligned fastening holes of the fastening sections, and a fastener may pass through the aligned fastening holes and is coupled with the fastening groove in the barrier to couple together and electrically connect the fastening sections.

An outwardly facing surface of the fastening section of the first connecting member of the first battery may be parallel with and on a different plane from an outwardly facing surface of the fastening section of the second connecting member of the second battery.

An inwardly facing surface of the fastening section of the first connecting member of the first battery may be parallel with and coplanar with the outwardly facing surface of the fastening section of the second connecting member of the second battery.

The first material may be one of copper or aluminum, and the second material may be another of copper or aluminum.

### BRIEF DESCRIPTION OF THE DRAWINGS

Features will be apparent to those of skill in the art by describing in detail exemplary embodiments with reference to the attached drawings in which:

FIG. 1 illustrates a perspective view of a battery pack according to an embodiment.

FIG. 2 illustrates a perspective view of a battery cell of the battery pack according to an embodiment.

FIG. 3 illustrates a perspective view of a state in which connecting members are bonded to the battery cell of FIG. 2.

FIG. 4 illustrates a perspective view of a state in which a barrier is coupled to a battery module according to an embodiment.

FIG. 5 illustrates a front view of a state in which the barrier is coupled to the battery module according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will be understood that when an element is referred to as being “between” two elements, it can be the only element between the two elements, or one or more intervening elements may also be present.

In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween.

An embodiment may provide a battery pack, including, e.g., a plurality of battery cells each configured to have first and second electrode terminals formed to be exposed to the top thereof, the first and second electrode terminals being made of different kinds of materials, wherein a first battery cell includes: a first connecting member made of the same kind of material as a first electrode terminal of the first battery cell, the first connecting member having one end bonded to the first electrode terminal of the first battery cell and the other end provided with a fastening hole for electrical connection with a second electrode terminal of a second battery cell adjacent to the first battery cell; and a second connecting member made of the same kind of material as a second electrode terminal of the first battery cell, the second connecting member having one end bonded to the second electrode terminal of the first battery cell and the other end provided with a fastening hole for electrical connection with a first electrode terminal of a third battery cell adjacent to the first battery cell.

The first connecting member may include a first bonding portion bonded to the top of the first electrode terminal of the first battery cell; a first fastening portion formed to extend toward the second battery cell at the top of the first bonding portion, the first fastening portion including a fastening hole for electrical connection with the second electrode terminal of the second battery cell; and a first connecting portion formed to connect the first bonding portion and the first fastening portion, which exist on different planes from each other.

The second connecting member may include a second bonding portion bonded to the top of the second electrode terminal of the first battery cell; a second fastening portion formed to extend toward the third battery cell at the top of the second bonding portion, the second fastening portion including a fastening hole for electrical connection with the first electrode terminal of the third battery cell; and a second connecting portion formed to connect the second bonding portion and the second fastening portion, which exist on different planes from each other.

The second battery cell may include a second connecting member made of the same kind of material as the second electrode of the second battery cell, the second connecting member having one end bonded to the second electrode terminal of the second battery cell and the other end provided with a fastening hole for electrical connection with the first electrode terminal of the first battery cell. The second connecting member of the second battery cell may include a second bonding portion bonded to the top of the second electrode terminal of the second battery cell; a second fastening portion formed to extend toward the first battery cell at the top of the second bonding portion of the second battery cell, the second fastening portion including a fastening hole for electrical connection with the first electrode terminal of the first battery cell; and a second connecting portion formed to connect the second bonding portion and the second fastening portion of the second battery cell, which exist on different planes from each other. The first fastening portion of the first battery cell may be formed on a plane lower than that of the second fastening portion of the second battery cell.

At least portions of the first fastening portion of the first battery cell and the second fastening portion of the second battery cell may be overlapped with each other in a state in which the centers of their fastening holes correspond to each other.

The third battery cell may include a first connecting member made of the same kind of material as the first electrode terminal of the third battery cell, the first connecting member having one end bonded to the first electrode terminal of the third battery cell and the other end provided with a fastening hole for electrical connection with the second electrode terminal of the first battery cell. The first connecting member of the third battery cell may include a first bonding portion bonded to the top of the first electrode terminal of the third battery cell; a first fastening portion formed to extend toward the first battery cell at the top of the first bonding portion of the third battery cell, the first fastening portion including a fastening hole for electrical connection with the second electrode terminal of the first battery cell; and a first connecting portion formed to connect the first bonding portion and the first fastening portion of the third battery cell, which exist on different planes from each other. The second fastening portion of the first battery cell may be formed on a plane lower than that of the first fastening portion of the third battery cell.

At least portions of the second fastening portion of the first battery cell and the first fastening portion of the third battery cell may be overlapped with each other in a state in which the centers of their fastening holes correspond to each other.

The battery pack may further include a plurality of barriers respectively interposed between the plurality of battery cells.

A first barrier interposed between the first and second battery cells may be provided with a fastening groove which corresponds to the centers of the fastening hole of the first fastening portion of the first battery cell and the fastening hole of the second fastening portion of the second battery cell.

The fastening groove may be a nut member.

The fastening hole of the first fastening portion of the first battery cell, the fastening hole of the second fastening portion of the second battery cell, and the nut member of the first barrier may be coupled to one another by one bolt member.

The bolt member may be fastened to the nut member of the first barrier through the fastening hole of the first fastening portion of the first battery cell and the fastening hole of the second fastening portion of the second battery cell.

A second barrier interposed between the first and third battery cells may be provided with a fastening groove which corresponds to the centers of the fastening hole of the second fastening portion of the first battery cell and the fastening hole of the first fastening portion of the third battery cell.

The fastening groove may be a nut member.

The fastening hole of the second fastening portion of the first battery cell, the fastening hole of the first fastening portion of the third battery cell, and the nut member of the second barrier may be coupled to one another by one bolt member.

The bolt member may be fastened to the nut member of the second barrier through the fastening hole of the second fastening portion of the first battery cell and the fastening hole of the first fastening portion of the third battery cell.

The first and second connecting members may be respectively bonded to the first and second electrode terminals of the first battery cell through laser welding.

The first electrode terminal may be made of an aluminum material, and the second electrode terminal may be made of a copper material.

The plurality of battery cells may be arranged in parallel by turns.

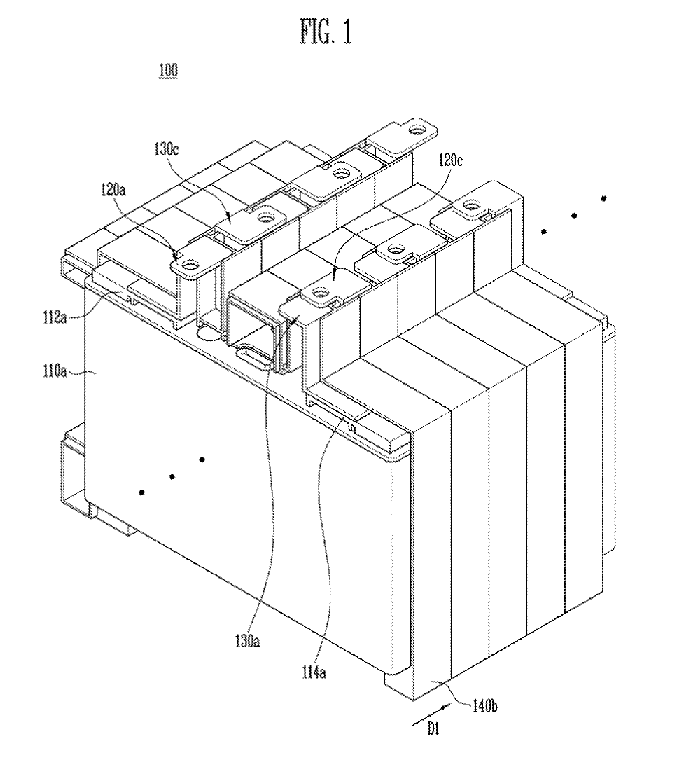

FIG. 1 illustrates a perspective view of a battery pack 100 according to an embodiment.

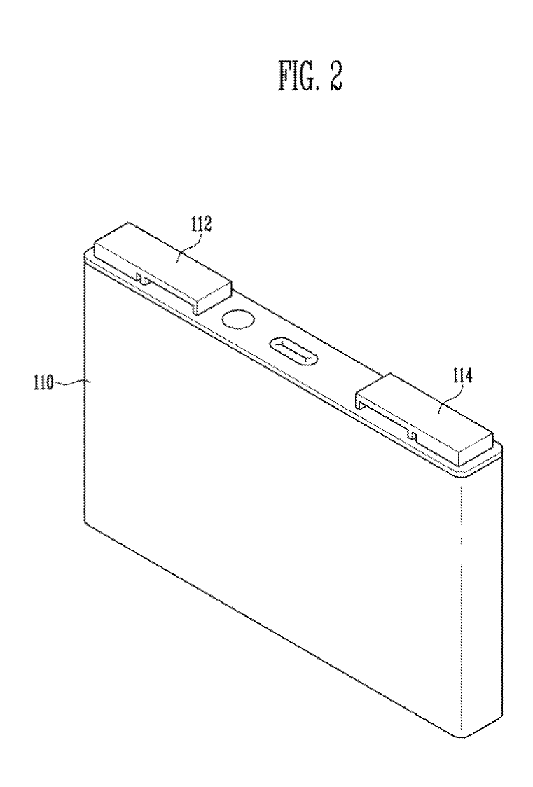

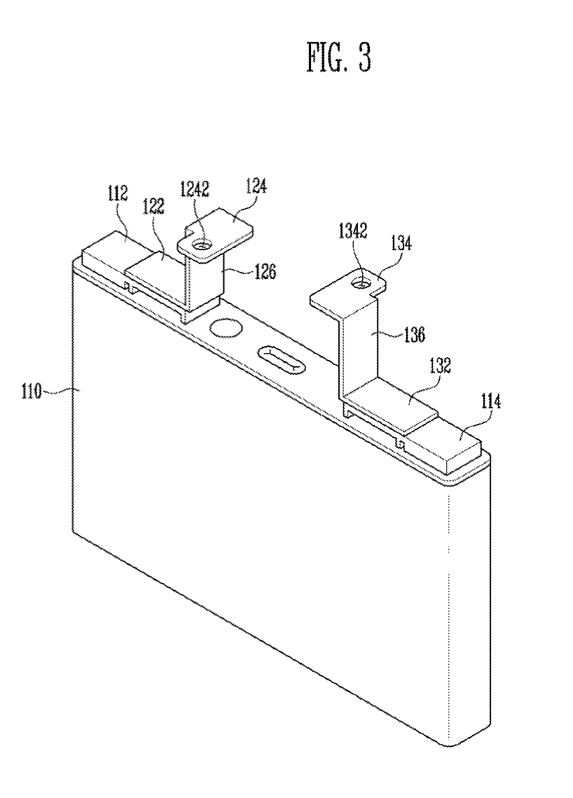

FIG. 2 illustrates a perspective view of a battery cell 110 of the battery pack 100 according to an embodiment. FIG. 3 illustrates a perspective view of a state in which connecting members 120 and 130 are bonded to the battery cell 110 of FIG. 2 (hereinafter, referred to as a ‘battery module’ for convenience of illustration).

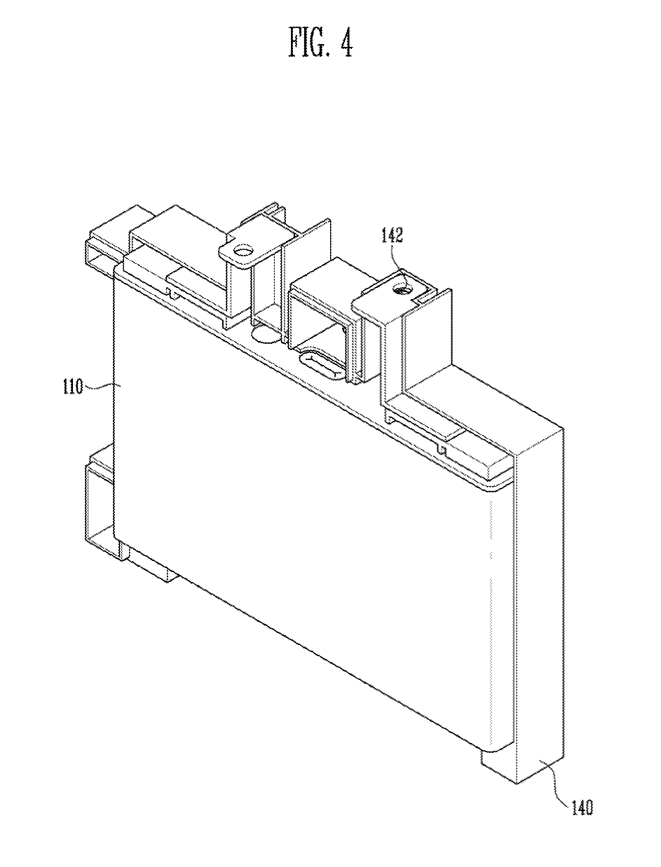

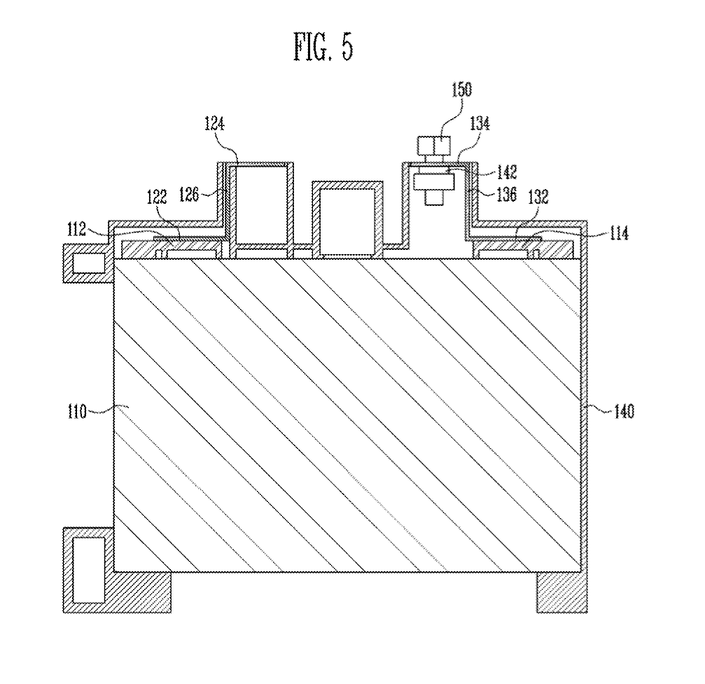

FIG. 4 illustrates a perspective view of a state in which a barrier 140 is coupled to a battery module 110, 120, or 130 according to an embodiment. FIG. 5 illustrates a front view of a state in which the barrier 140 is coupled to the battery module 110, 120, or 130 according to an embodiment.

First, as shown in FIG. 1, the battery pack 100 according to an embodiment may include a plurality of battery cells 110 (each having first and second terminals or electrode terminals 12 and 14 exposed at a top thereof). The first and second terminals 12 and 14 may be made of different materials. First and second connecting members 120 and 130 may electrically connect the plurality of battery cells 110; and a plurality of barriers 140 may be respectively interposed between the plurality of battery cells 110.

For example, the plurality of battery cells 110 may be repeatedly arranged or aligned with one another (e.g., such that sides thereof are in parallel) in a first direction Dl. The barriers 140 may be interposed between the battery cells 110. Two connecting members 120 and 130 may be provided on each battery cell 110 so as to connect the battery cells 110 to each other. For example, the connecting member may be a bus-bar.

For example, the two connecting members 120 and 130 on each battery cell 110 may extend or protrude in directions opposite to each other and/or toward adjacent battery cells, so that a serial connection between the battery cells may be effected.

For example, the battery cell 110 positioned at the front in FIG. 1 may be referred to as a first battery cell 110a. Although not shown in FIG. 1, a battery cell to be disposed further forward than the first battery cell 110a may be referred to as a second battery cell 110b (to be connected in series to the first battery cell 110a), and the battery cell disposed further backward than the first battery cell 110a may be referred to as a third battery cell 110c. For example, a first connecting member 120a (of two connecting members 120a and 130a) on the first battery cell 110a may be connected to a second connecting member 130b (of two connecting members 120b and 130b, which may protrude or extend toward the second battery cell 110b that is adjacent to the first battery cell 110a) on the second battery cell 120b.

For example, the second connecting member 130b of the second battery cell 110b may also protrude or extend toward the first battery cell 110a (adjacent to the second battery cell 110b), and a first connecting member 120b may protrude or extend toward another battery cell (adjacent to the second battery cell 110b).

In addition to the first connecting member 120a of the first battery cell 110a, a second connecting member 130a may protrude or extend toward the third battery cell 110c adjacent to the first battery cell 110a. For example, the second connecting member 130a may be connected to a first connecting member 120c of two connecting members 120c and 130c of the third battery cell 110c.

In an implementation, the first connecting member 120c of the third battery cell 110c may also protrude or extend toward the first battery cell 110a adjacent to the third battery cell 110c, and a second connecting member 130c of the third battery cell 110c may protrude or extend toward another battery cell adjacent to the third battery cell 110c.

As such, as the two connecting members 120 and 130 on each battery cell protrude or extend in directions opposite to each other and toward different adjacent battery cells, bolt fastening between the connecting members opposite to each other may be used to establish the serial connection between the battery cells.

For example, the first connecting member 120 of the first battery cell and the second connecting member 130b of the second battery cell, which may be opposite to each other, may be bolt-fastened to each other (e.g., with a bolt and a nut or nut-like member), and the second connecting member 130a of the first battery cell and the first connecting member 120c of the third battery cell, which may be opposite to each other, may also be bolt-fastened to each other.

The two connecting members 120 and 130 on each battery cell 110 may be bonded to or otherwise coupled with the terminals of the battery cell so as to be firmly fixed. The bonding may include, e.g., laser welding.

For example, according to an embodiment, one end of each connecting member 120 and 130 of each battery cell 110 may be bonded to the terminal through laser welding, and another end of the connecting member may be coupled to the connecting member of an adjacent battery cell through bolt fastening.

Accordingly, in the connection between the battery cells 110 having a molding terminal structure shown in FIG. 2 and FIG. 3, a copper connecting member 120 (made of a same kind of material as the negative electrode terminal 112) may be welded to the negative electrode 112 (e.g., made of a copper material), and the aluminum connecting member 130 (made of a same kind of material as the positive electrode 114) may be welded to the positive electrode 114 (e.g., made of an aluminum material). Then, as shown in FIG. 1, the two connecting members opposite to each other and between the adjacent battery cells may be bolt-fastened to each other, thereby finally constituting the battery pack 100.

Thus, according to an embodiment, it is possible to facilitate working conditions without welding between different kinds of metals, and to reduce a failure rate. For example, a bolt may pass through aligned fastening holes and a nut may be on the bolt, the bolt and nut being coupled with the fastening section of the first connecting member of the first battery and the fastening section of the second connecting member of the second battery.

Hereinafter, the battery pack 100 according to this embodiment will be described in detail with reference to FIGS. 1 to 5. For convenience of illustration, the first battery cell 110 positioned at the front in FIG. 1, the first and second connecting members 120a and 130 on the first battery cell 110, and a first barrier 140a between the first and third battery cells 110a and 110c will be mainly described. However, the same description may be applicable to the other battery cells.

First, as shown in FIGS. 2 and 3, the first connecting member 120a on the first battery cell 110a may include a first bonding or terminal section 122a bonded to the top of the first terminal 112a of the first battery cell 110a; a first fastening section 124a extending toward the second battery cell 110b from a top of the first terminal section 122a, the first fastening section 124a including a fastening hole 1242a (for electrical connection with the second terminal 114b of the second battery cell 110b); and a first connecting or intermediate section 126a connecting the first terminal section 122a and the first fastening section 124a. The first terminal section 122a, the first intermediate section 126a, and the first fastening section 124a may exist or be present on different planes from each other. For example, major surfaces of the plate-shaped first terminal section 122a, the plate-shaped first intermediate section 126a, and the plate-shaped first fastening section 124a may be on different planes. For example, each fastening section may include a protruding section, the protruding section including the fastening hole therein. For example, the fastening hole in the fastening section of the first connecting member of the first battery may be aligned with the fastening hole in the fastening section of the second connecting member of the second battery.

For example, the first terminal section 122a may be on a first plane P1 (parallel to a plane of the first terminal 112a), and the first fastening section 124a may be on a second plane P2 (parallel to the first plane P1) and above or spaced apart from the first plane P1.

The second connecting member 130 on the first battery cell 110a may include a second terminal section 132a (that is bonded to the top of the second terminal 114a of the first battery cell 110a); a second fastening section 134a (extending toward the third battery cell 110c at the top of the second bonding section 132a), the second fastening section 134a including a fastening hole 1342a for electrical connection with the first terminal 112c of the third battery cell 110c; and a second intermediate section 136a (connecting the second terminal section 132a and the second fastening section 134a). The second terminal section 132a, the second intermediate section 136a, and the second fastening section 134a may exist or be present on different planes from each other.

For example, the second terminal section 132a may be on the first plane P1 (parallel to the plane on of second terminal 114a), and the second fastening second 134a may be on the second plane P2 (parallel to the first plane P1 and above the first plane P1).

For example, the first and second terminals 112a and 114a may be on the same plane (e.g., outer flat surfaces of the first and second terminals 112a and 114a may be on a same plane). Thus, the first and second terminal sections 122a and 132a may be on the same first plane P1, and the first and second fastening sections 124a and 134a may also be on the same second plane P2. In an implementation, the first and second fastening sections 124a and 134a may be on different planes.

Similar to the first battery cell 110a, the second battery cell (as described above, although not shown in these figures, its reference numeral is designated by 110b for convenience of illustration) adjacent to the first battery cell 110a may include a second connecting member 130b made of the same kind of material as the second terminal 114b of the second battery cell 110b, the second connecting member 130b having one end bonded to the second terminal 114b of the second battery cell 110b and another end including a fastening hole (for electrical connection with the first electrode terminal 112a of the first battery cell 110a).

For example, the second connecting member 130b on the second battery cell 110b may include a second terminal section 132b bonded to the top of the second terminal 114b of the first battery cell 110b; a second fastening section 134b extending toward the first battery cell 110a at the top of the second terminal section 132b, the second fastening section 134b including a fastening hole 1342b for electrical connection with the first terminal 112a of the first battery cell 110a; and a second intermediate section 136b connecting the second terminal section 132b and the second fastening section 134b. The second terminal section 132b, the second intermediate section 136b, and the second fastening section 134b may be on different planes from each other.

For example, the second terminal section 132b may be on the first plane P1 (e.g., parallel to the plane of second terminal 114b), and the second fastening section 134b may be on a third plane P3 (parallel to the first plane P1 and above the first plane P1).

In an implementation, in the serial connection between the adjacent battery cells 110a and 110b, the first fastening section 124a of the first battery cell 110a may be on a plane that is different from, e.g., lower than, that of the second fastening section 134b of the second battery cell 110b, in order to facilitate the bolt fastening between the connecting members opposite to each other.

For example, the plane P2 of an outwardly facing side of the first fastening section 124a of the first battery cell 110a may be lower than the plane P3 of an outwardly facing side of the second fastening section 134b of the second battery cell 110b. For example, the outwardly facing side of the first fastening section 124a of the first battery cell 110a may be on a same plane P2 as an inwardly facing side of the second fastening section 134b of the second battery cell 110b.

Accordingly, at least portions of the first fastening section 124a (of the first battery cell 110a) and the second fastening section 134b (of the second battery cell 110b) may overlap with each other in a state in which centers of their fastening holes 1242a and 1342b correspond to or are aligned with each other. As a result, the bolt fastening between the connecting members 120a and 130b opposite to each other may be facilitated.

The second battery cell 110b may also include a first connecting member 120b, and the first connecting member 120 may have the same structure as the first connecting member 120c of the third battery cell 110c. Therefore, a detailed description thereof may be substituted with the following descriptions.

The third battery cell 110c (adjacent to the first battery cell 110a in the first direction D1) may also include a first connecting member 120c (made of the same kind of material as the first electrode terminal 112c of the third battery cell 110c), the first connecting member 120c (having one end bonded to the first terminal 112c of the third battery cell 110c and another end including a fastening hole for electrical connection with the second terminal 114a of the first battery cell 110a).

For example, the first connecting member 120c of the third battery cell 110c may include a first terminal section 122c (bonded to a top of the first terminal 112c of the third battery cell 110c); a first fastening section 124c (protruding or extending toward the first battery cell 110a at the top of the first terminal section 122c), the first fastening section 124c including a fastening hole 1242c for electrical connection with the second terminal 114a of the first battery cell 110a; and a first intermediate section 126c (connecting the first terminal section 122c and the first fastening section 124c). The first terminal section 122c, the first intermediate section 126c, and the first fastening section 124c may be on different planes from each other.

For example, the first terminal section 122c may be on the first plane P1 parallel to the plane of the first terminal 112c, and the first fastening section 124c may be on the third plane P3 parallel to the first plane P1 and above the first plane P1.

For example, as described above, in the serial connection between the adjacent battery cells, the second fastening section 134a of the first battery cell 110a may be on a plane that is different from, e.g., lower than, that of the first fastening section 124c of the third battery cell 110c in order to facilitate bolt fastening between the connecting members that are opposite to each other.

For example, the plane P2 (of the second fastening section 134a of the first battery cell 110a) may be lower than the plane P3 (of the first fastening section 124c of the third battery cell 110c).

Accordingly, at least portions of the second fastening section 134a of the first battery cell 110a and the first fastening section 124c of the third battery cell 110c may overlap with each other in a state in which centers of their fastening holes 1342a and 1242c correspond to or are aligned with each other. As a result, the bolt fastening between the connecting members 130a and 120c opposite to each other may be facilitated.

For example, the fastening sections 124a and 134a of the connecting member of the first battery cell may be on a plane that is different from, e.g., lower than, that of the first and second fastening sections 124c and 134b of the connecting members of the adjacent battery cells, so that the bolt fastening between the connecting members opposite to each other is possible in the serial connection between the battery cells.

The third battery cell 110c may also include a second connecting member 130c, and the second connecting member 130c may have the same structure as the second connecting member 130b of the second battery cell 110b described above. Therefore, a repeated detailed description thereof may be omitted.

As shown in FIGS. 1 to 5, a first barrier 140 (e.g., 140a, for convenience of illustration) between the first and second battery cells 110a and 110b may include a fastening groove 142a that corresponds to, is aligned with, or underlies the centers of the fastening hole 1242a of the first fastening section of the first battery cell and the fastening hole 1342b of the second fastening section of the second battery cell.

According to an embodiment, the fastening groove 142a may be a nut member, and the fastening hole 1242a of the first fastening section of the first battery cell, the fastening hole 1342b of the second fastening section of the second battery cell, and the nut member 142a of the first barrier may be coupled to one another by a bolt member or bolt 150.

For example, the bolt 150 may be fastened to a nut or the nut member 142a of the first barrier through the fastening hole 1242a of the first fastening section of the first battery cell and the fastening hole 1342b of the second fastening section of the second battery cell.

In the same manner, a second barrier (e.g., 140b) between the first and third battery cells 110a and 110c may include a fastening groove 142b that corresponds to, is aligned with, or underlies the centers of the fastening hole 1342a of the second fastening section of the first battery cell and the fastening hole 1242c of the first fastening section of the third battery cell.

For example, the fastening groove 142b may be a nut-like member, and the fastening hole 1342a of the second fastening section of the first battery cell, the fastening hole 1242c of the first fastening section of the third battery cell, and the nut member 142b of the second barrier may be coupled to one another by another bolt 150.

For example, the bolt may be fastened to the nut member 142b of the second barrier through the fastening hole 1342a of the second fastening section of the first battery cell and the fastening hole 1242c of the first fastening section of the third battery cell.

By way of summation and review, a serial connection between battery cells may be made through a separate connecting member, and the positive electrode of any one of a pair of battery cells adjacent to each other, which belong to the battery cell assembly, may be connected to the negative electrode of the other of the pair of battery cells through the connecting member.

The bonding between the electrode of the battery cell and the connecting member may be made by welding. For example, welding between different kinds of metals may be difficult. For example, a high failure rate and complicated working conditions may occur.

According to an embodiment, a module structure may be made by previously or initially welding a connecting member (made of the same material as a terminal) to the terminal of each battery cell, using a laser, and then stacking the connecting members. The connecting members may then assembled or coupled using a bolt, so that it is possible to simplify work. When a welding failure occurs, only a corresponding cell may be removed, so that it is possible to minimize loss caused by the welding failure.

The embodiments may provide a battery pack that may help reduce failure rate and may help improve working conditions without any difficulty of welding between different kinds of metals in connection between battery cells.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a first battery; and
a second battery that is electrically connected to the first battery,
wherein:
each of the first battery and the second battery include:
a first terminal, the first terminal being formed of a first material,
a second terminal, the second terminal being formed of a second material that is different from the first material, and the second terminal having an opposite polarity from that of the first terminal,
a first connecting member welded to the first terminal, the first connecting member being formed of the first material; and
a second connecting member welded to the second terminal, the second connecting member being formed of the second material, and
the first connecting member of the first battery is electrically connected with the second connecting member of the second battery.

2. The battery pack as claimed in claim 1, wherein the first connecting member and the second connecting member each include a terminal section that is welded to the terminal, a fastening section at an end of the connecting member opposite to the terminal section, and an intermediate section that connects the terminal section and the fastening section.

3. The battery pack as claimed in claim 1, wherein a plane of the terminal section is parallel with a plane of the fastening section.

4. The battery pack as claimed in claim 3, wherein a plane of the intermediate section is perpendicular to the plane of terminal section and the fastening section.

5. The battery pack as claimed in claim 1, wherein:
each fastening section includes a protruding section, the protruding section including a fastening hole therein, and
the fastening hole in the fastening section of the first connecting member of the first battery is aligned with the fastening hole in the fastening section of the second connecting member of the second battery.

6. The battery pack as claimed in claim 5, further comprising:
a bolt passing through the aligned fastening holes; and
a nut on the bolt, the bolt and nut being coupled with the fastening section of the first connecting member of the first battery and the fastening section of the second connecting member of the second battery.

7. The battery pack as claimed in claim 5, wherein the protruding section of the first connecting member protrudes outwardly from the battery in a direction opposite to a direction in which the protruding section of the second connecting member protrudes.

8. The battery pack as claimed in claim 5, further comprising a barrier between the first battery and the second battery.

9. The battery pack as claimed in claim 8, wherein:
the barrier includes a fastening groove that is aligned with the aligned fastening holes of the fastening sections, and
a fastener passes through the aligned fastening holes and is coupled with the fastening groove in the barrier to couple together and electrically connect the fastening sections.

10. The battery pack as claimed in claim 2, wherein an outwardly facing surface of the fastening section of the first connecting member of the first battery is parallel with and on a different plane from an outwardly facing surface of the fastening section of the second connecting member of the second battery.

11. The battery pack as claimed in claim 10, wherein an inwardly facing surface of the fastening section of the first connecting member of the first battery is parallel with and coplanar with the outwardly facing surface of the fastening section of the second connecting member of the second battery.

12. The battery pack as claimed in claim 1, wherein:
the first material is one of copper or aluminum, and
the second material is another of copper or aluminum.
